(19) United States
(12) Patent Application Publication
(10) Pub. No.: US 2020/0201716 A1
(43) Pub. Date: Jun. 25, 2020

(54) SYSTEM AND METHOD FOR PROPAGATING CHANGES IN FREEFORM DIAGRAMS

(71) Applicant: HCL TECHNOLOGIES LIMITED, Uttar Pradesh (IN)

(72) Inventors: Sandeep KATOCH, Frisco, TX (US); Sreenivasulu VALMETI, Bangalore (IN); Badrinarayan RAVICHANDRAN, Bangalore (IN)

(21) Appl. No.: 16/228,296

(22) Filed: Dec. 20, 2018

(51) Int. Cl. G06F 11/14; G06F 3/06

(52) U.S. Cl. CPC G06F 11/1435; G06F 3/0614; G06F 3/065

(57) ABSTRACT

A system for propagating changes in freeform diagrams is configured to generate a diagram element corresponding to an underlying model element, wherein the underlying model element represents characteristic features associated with the diagram element. Further, the system may identify a subset of files from a set of files with the diagram element. Further, the system may maintain a correlation data corresponding to each file from the subset of files, and the underlying model element. The system may detect change in the diagram element and update the correlation data and underlying model element thereby propagating changes in a set of files.

### CROSS-REFERENCE TO RELATED APPLICATIONS AND PRIORITY

The present application does not claim priority from any patent application.

### TECHNICAL FIELD

The present disclosure in general relates to the field of to the field of freeform diagrams. More particularly, the present invention relates to a system and method, for propagating changes in freeform diagrams.

### BACKGROUND

Freeform design tools like Microsoft Visio, enable a user to re-use diagram elements across different diagrams by using copy paste function. By using the copy-past function, a user can draw and update diagrams rapidly. However, changes made to the original diagram element are not applied to its copies. In such cases, users have to manually make the same change to all the copies to ensure consistency.

### SUMMARY

Before the present systems and method for propagating changes in freeform diagrams is illustrated. It is to be understood that this application is not limited to the particular systems, and methodologies described, as there can be multiple possible embodiments that are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for propagating changes in freeform diagrams. This summary is not intended to identify essential features of the claimed subject matter nor is it intended for use in determining or limiting the scope of the claimed subject matter.

In one implementation, a system for propagating changes in freeform diagrams is illustrated. The system comprises a memory and a processor coupled to the memory, wherein the processor is configured to execute programmed instructions stored in the memory to generate an underlying model element corresponding to a diagram element. The diagram element is generated over a drawing canvas of a file from a set of files. The set of files are associated with a freeform design tool. The underlying model element represents characteristic features associated with the diagram element, and wherein the set of files and the underlying model element are stored in a repository. Further, the processor is configured to execute programmed instructions stored in the memory to identify a subset of files from a set of files with the diagram element, wherein the diagram element is replicated in the subset of files from the set of files. Further, the processor is configured to execute programmed instructions stored in the memory to maintain a correlation data corresponding to each file from the subset of files and the underlying model element. Further, the processor is configured to execute programmed instructions stored in the memory to detect a change in the diagram element associated with a target file from the subset of files. Further, the processor is configured to execute programmed instructions stored in the memory to update the underlying model element to generate an updated underlying model element based on the change in the diagram element associated with a target file. Further, the processor is configured to execute programmed instructions stored in the memory to update one or more files from the subset of files based on the correlation data and updated underlying model element.

In one implementation, a method for propagating changes in freeform diagrams is illustrated. The method may comprise steps to generate the underlying model element corresponding to the diagram element. The diagram element is generated over the drawing canvas of a file from a set of files. The set of files are associated with the freeform design tool. The underlying model element represents characteristic features associated with the diagram element, and wherein the set of files and the underlying model element are stored in a repository. Further, the method may comprise steps to identify the subset of files from the set of files with the diagram element, wherein the diagram element is replicated in the subset of files from the set of files. Further, the method may comprise steps to maintain the correlation data corresponding to each file from the subset of files and the underlying model element. Further, the method may comprise steps to detect a change in the diagram element associated with the target file from the subset of files. Further, the method may comprise steps to update the underlying model element to generate the updated underlying model element based on the change in the diagram element associated with the target file. Further, the method may comprise steps to update one or more files from the subset of files based on the correlation data and updated underlying model element.

In yet another implementation, a computer program product having embodied computer program for propagating changes in freeform diagrams is disclosed. The program may comprise a program code to generate the underlying model element corresponding to a diagram element. The diagram element is generated over the drawing canvas of a file from a set of files. The set of files are associated with the freeform design tool. The underlying model element represents characteristic features associated with the diagram element, and wherein the set of files and the underlying model element are stored in the repository. The program may comprise the program code to identify a subset of files from a set of files with the diagram element, wherein the diagram element is replicated in the subset of files from the set of files. The program may comprise the program code to maintain the correlation data corresponding to each file from the subset of files and the underlying model element. The program may comprise the program code to detect the change in the diagram element associated with the target file from the subset of files. The program may comprise the program code to update the underlying model element to generate the updated underlying model element based on the change in the diagram element associated with a target file. The program may comprise the program code to update one or more files from the subset of files based on the correlation data and updated underlying model element.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system configured for propagating changes in freeform diagrams, in accordance with an embodiment of the present subject matter.

FIG. 2 illustrates the system configured for propagating changes in freeform diagrams, in accordance with an embodiment of the present subject matter.

FIG. 3 illustrates a method for propagating changes in freeform diagrams, in accordance with an embodiment of the present subject matter.

### DETAILED DESCRIPTION

Some embodiments of the present disclosure, illustrating all its features, will now be discussed in detail. The words “generating”, “identifying”, “maintaining”, “detecting”, “updating” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used for propagating changes in freeform diagrams, the exemplary, systems and method for pre-processing of the image is now described.

Various modifications to the embodiment will be readily apparent to those skilled in the art and the generic principles herein may be applied to other embodiments. However, one of ordinary skill in the art will readily recognize that the present disclosure for propagating changes in freeform diagrams is not intended to be limited to the embodiments illustrated but is to be accorded the widest scope consistent with the principles and features described herein.

The system enables propagating changes in freeform diagrams. In one embodiment, the system may generate an underlying model element corresponding to a diagram element. The diagram element is generated over a drawing canvas of a file from a set of files. The set of files are associated with a freeform design tool. The underlying model element represents characteristic features associated with the diagram element, and wherein the set of files and the underlying model element are stored in a repository. Further, the system may identify a subset of files from a set of files with the diagram element, wherein the diagram element is replicated in the subset of files from the set of files. Further, the system may maintain a correlation data corresponding to each file from the subset of files and the underlying model element. Further, the system may detect a change in the diagram element associated with a target file from the subset of files. Further, the system may update the underlying model element to generate an updated underlying model element based on the change in the diagram element associated with a target file. Further, the the system may update one or more files from the subset of files based on the correlation data and the updated underlying model element.

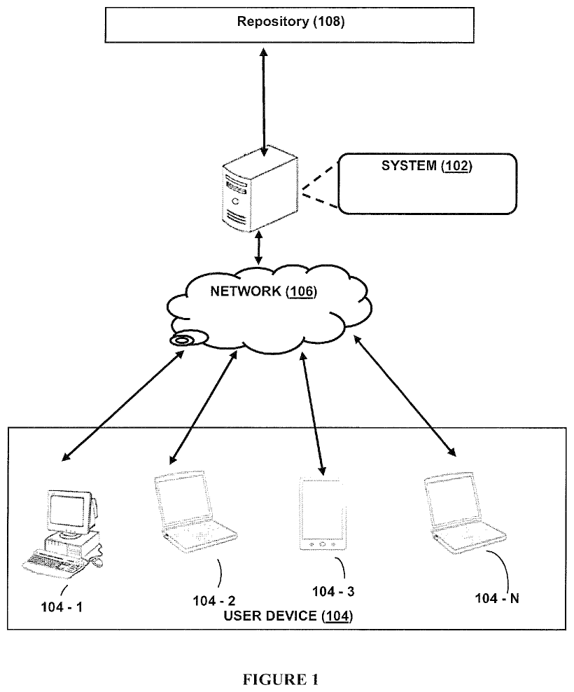

Referring now to FIG. 1, a network implementation 100 of a system 102 for propagating changes in freeform diagrams is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a server. Further, the system 102 may be implemented in a cloud network. In one embodiment, the system may be implemented as a Platform or database as a Service (PAAS). The system 102 may further be configured to communicate with a freeform diagram platform 108.

Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

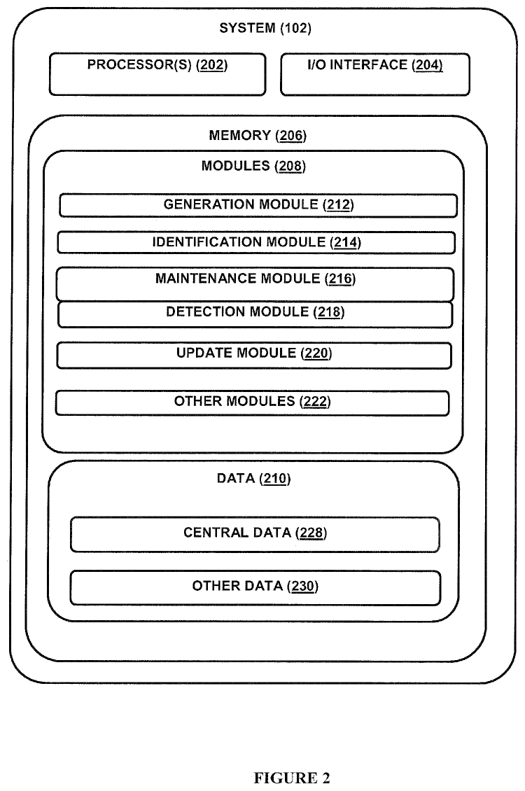

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), File Transfer Protocol (FTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like. In one embodiment, the system 102 may be configured to store a set of files associated with a freeform design tool over the repository 108. The set of files may be received form the freeform design tool. Once the system 102 receives the set of files, the system 102 is configured to process the set of files as described with respect to FIG. 2.

Referring now to FIG. 2, the system 102 is configured for propagating changes in freeform diagrams in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random-access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a generation module 212, an identification module 214, a maintenance module 216, a detection module 218, an update module 220 and other modules 222. The other modules 222 may include programs or coded instructions that supplement applications and functions of the system 102.

The data 210, amongst other things, serve as a repository for storing data processed, received, and generated by one or more of the modules 208. The data 210 may also include a central data 228, and other data 230. In one embodiment, the other data 230 may include data generated as a result of the execution of one or more modules in the other modules 222. In one implementation, a user may access the system 102 via the I/O interface 204. The user may be registered using the I/O interface 204 in order to use the system 102. In one aspect, the user may access the I/O interface 204 of the system 102 for accessing a file from the set of files stored at the repository 108. The functioning of all the modules in the system 102 is described as below:

### Generation Module 212

In the embodiment, the generation module 212 may be configured to generate an underlying model element corresponding to a diagram element. The diagram element is generated over a drawing canvas of the file based on user inputs received on the file from a set of files. The set of files are associated with the freeform design tool. In one embodiment, each file from the set of files correspond to freeform diagram. In one embodiment, the underlying model element represents characteristic features associated with the diagram element. In one embodiment, the set of files and the underlying model element are stored in the repository 108. Further, the characteristic features may correspond to shape, size, colour, background of the diagram element. The diagram element may correspond to a text box, a geometrical shape or any other graphical element sored in the file. The same diagram element may be copied by the user to one or more other files from the set of files. As soon as such an action is triggered, the generation module is configured to generate the underlying model element corresponding to a diagram element.

### Identification Module 214

In one embodiment, the diagram element may be replicated in a subset of files from the set of files. The diagram element may be replicated using copy-past operation. Further, the identification module 214 may identify the subset of files from a set of files with the diagram element.

### Maintenance Module 216

In one embodiment, once the subset of files is identified, the maintenance module 216 may be configured to maintain a correlation data corresponding to each file from the subset of files, and the underlying model element in the repository 108. The correlation data is indicative of type of changes accepted by each file from the subset of files. Each file from the set of files may be configured to propagate only a specific type of change based on user selection. For example, at the time of replicating the diagram element, a user may select option to propagate changes associated only with size and shape associated with the model element. This information is stored by the maintenance module 216 as correlation data. The correlation data is further used to propagate changes in the set of files.

### Detection Module 218

Further, the detection module 218 may be configured to detect change in the diagram element associated a target file from the subset of files. The change in the diagram element may correspond to change in shape, size, colour, background of the diagram element.

### Update Module 220

Further, the update module 220 may be configured to update the underlying model element to generate an updated underlying model element based on the change in the diagram element associated a target file. Further, the update module 220 may be configured to update one or more files from the subset of files based on the correlation data and the updated underlying model element.

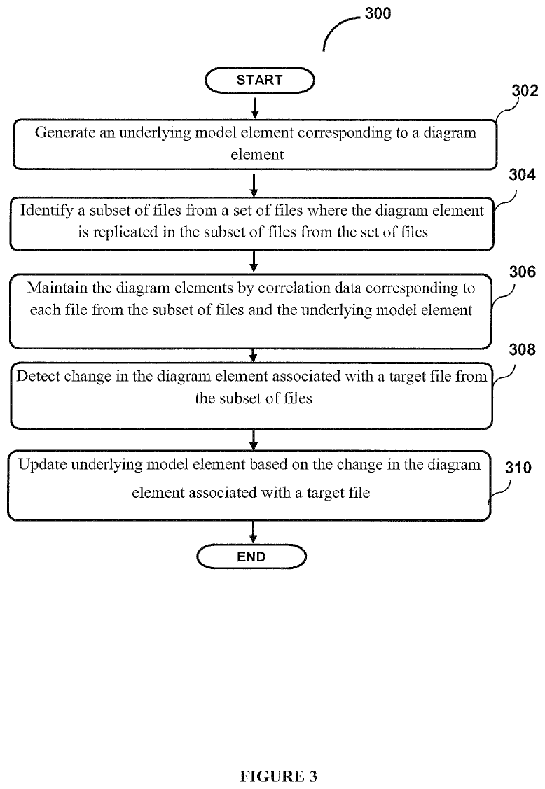

Referring now to FIG. 3, a method 300 for propagating changes in freeform diagrams, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the generation module 212 may be configured to generate an underlying model element corresponding to a diagram element. The diagram element is generated over a drawing canvas of the file based on user inputs received on the file from a set of files. The set of files are associated with the freeform design tool. In one embodiment, each file from the set of files correspond to freeform diagram. In one embodiment, the underlying model element represents characteristic features associated with the diagram element. In one embodiment, the set of files and the underlying model element are stored in the repository 108. Further, the characteristic features may correspond to shape, size, colour, background of the diagram element. The diagram element may correspond to a text box, a geometrical shape or any other graphical element sored in the file. The same diagram element may be copied by the user to one or more other files from the set of files. As soon as such an action is triggered, the generation module is configured to generate the underlying model element corresponding to the diagram element.

At block 304, the diagram element may be replicated in a subset of files from the set of files. The diagram element may be replicated using copy-past operation. Further, the identification module 214 may identify the subset of files from a set of files with the diagram element.

At block 306, once the subset of files is identified, the maintenance module 216 may be configured to maintain a correlation data corresponding to each file from the subset of files, and the underlying model element in the repository 108. The correlation data is indicative of type of changes accepted by each file from the subset of files. Each file from the set of files may be configured to propagate only a specific type of change based on user selection. For example, at the time of replicating the diagram element, a user may select option to propagate changes associated only with size and shape associated with the model element. This information is stored by the maintenance module 216 as correlation data. The correlation data is further used to propagate changes in the set of files.

At block 308, the detection module 218 may be configured to detect change in the diagram element associated a target file from the subset of files. The change in the diagram element may correspond to change in shape, size, colour, background of the diagram element.

At block 310, the update module 220 may be configured to update the underlying model element to generate an updated underlying model element based on the change in the diagram element associated a target file. Further, the update module 220 may be configured to update one or more files from the subset of files based on the correlation data and the updated underlying model element.

Although implementations for systems and methods for propagating changes in freeform diagrams has been described, it is to be understood that the appended claims are not necessarily limited to the specific features or methods described. Rather, the specific features and methods are disclosed as examples of implementations for propagating changes in freeform diagrams.

We claim:

1. A method for propagating changes in a set of files, the method comprises:
generating, by the processor, an underlying model element corresponding to a diagram element, wherein the diagram element is generated over a drawing canvas of a file from a set of files, wherein the set of files are associated with a freeform design tool, wherein the underlying model element represents characteristic features associated with the diagram element, and wherein the set of files and the underlying model element are stored in a repository;
identifying, by the processor, a subset of files from a set of files with the diagram element, wherein the diagram element is replicated in the subset of files from the set of files;
maintaining, by the processor, a correlation data corresponding to each file from the subset of files, and the underlying model element;
detecting, by the processor, change in the diagram element associated a target file from the subset of files;
updating, by the processor, the underlying model element to generate an updated underlying model element based on the change in the diagram element associated a target file; and
updating, by the processor, one or more files from the subset of files based on the correlation data and the updated underlying model element thereby propagating changes in a set of files.

2. The method of claim 1, wherein the characteristic features comprise at least one of shape, size, color, or background of the diagram element.

3. The method of claim 1, wherein the change in the diagram element corresponds to at least one of change in shape, size, colour, or background of the diagram element.

4. The method of claim 1, wherein the correlation data is indicative of type of changes accepted by each file from the subset of files.

5. A system for propagating changes in a set of files, the system comprises:
a memory;
a processor coupled to the memory, wherein the processor is configured to execute programmed instructions stored in the memory for:
generating an underlying model element corresponding to a diagram element, wherein the diagram element is generated over a drawing canvas of a file from a set of files, wherein the set of files are associated with a freeform design tool, wherein the underlying model element represents characteristic features associated with the diagram element, and wherein the set of files and the underlying model element are stored in a repository;
identifying a subset of files from a set of files with the diagram element, wherein the diagram element is replicated in the subset of files from the set of files;
maintaining a correlation data corresponding to each file from the subset of files, and the underlying model element;
detecting change in the diagram element associated a target file from the subset of files;
updating the underlying model element to generate an updated underlying model element based on the change in the diagram element associated a target file; and
updating one or more files from the subset of files based on the correlation data and the updated underlying model element thereby propagating changes in a set of files.

6. The system of claim 5, wherein the characteristic features comprise at least one of shape, size, colour, or background of the diagram element.

7. The system of claim 5, wherein the change in the diagram element corresponds to change in at least one of shape, size, colour, or background of the diagram element.

8. The system of claim 5, wherein the correlation data is indicative of type of changes accepted by each file from the subset of files.

9. A computer program product having embodied thereon a computer program for propagating changes in freeform diagrams, the computer program product comprises:
a program code for generating an underlying model element corresponding to a diagram element, wherein the diagram element is generated over a drawing canvas of a file from a set of files, wherein the set of files are associated with a freeform design tool, wherein the underlying model element represents characteristic features associated with the diagram element, and wherein the set of files and the underlying model element are stored in a repository;
a program code for identifying a subset of files from a set of files with the diagram element; wherein the diagram element is replicated in the subset of files from the set of files;
a program code for maintaining a correlation data corresponding to each file from the subset of files, and the underlying model element;
a program code for detecting change in the diagram element associated a target file from the subset of files;
updating, by the processor, the underlying model element to generate an updated underlying model element based on the change in the diagram element associated a target file; and
updating, by the processor, one or more files from the subset of files based on the correlation data and the updated underlying model element thereby propagating changes in a set of files.
